(19) United States
(12) Patent Application Publication
(10) Pub. No.: US 2011/0061040 A1
(43) Pub. Date: Mar. 10, 2011

(54) Association rule mining to predict co-varying software metrics

(76) Inventors: Muhammad Shaheen, Lahore (PK); Muhammad Shahbaz, Lahore (PK)

(21) Appl. No.: 12/554,914

(22) Filed: Sep. 6, 2009

(51) Int. Cl. G06F 9/44

(52) U.S. Cl. 717/100

(57) ABSTRACT

The present invention relates in general to the field of database analysis from software metrics database. In one aspect the present invention relates to the method for finding association rules contained in database records and in another it relates to software engineering to enhance the ability of source code to change and keep the components of code from failing.

Software evolves in releases or in versions; and every release needs major investment of time and effort. Every new entrant in software development faces a number of challenges in creating stable software especially when the previous releases are built by using object-oriented technologies. This situation can be avoided either by making the software easily changeable or by ensuring that fewer changes will be required in the future releases of the software. In this invention, is reported a method to find prominent factors in source code development that affect the ease of changeability and estimation of failure proneness of object-oriented source code modules. The present invention resolves the existing problems by finding a set of prominent factors represented by software metrics considering changeability and non-failure proneness as success indicators for object oriented source code. While it is relatively easy to predict the effect of one of the factors at a time, the process mined complexity and object oriented metrics to evaluate more than one critical factor by finding correlation of these metrics with success indicators. In this invention, an a priori algorithm is applied for making the frequent-metrics set that vary together to affect the success indicators, hence affecting the success of object-oriented source code modules. The resulting association rules are validated against the data from software industries and testing a broad range of large databases validates the invention.

The invention can be generalized to arbitrary modules. In the basic form the invention groups various contributing aspects of software product design in such a way that if one aspect is stroked, it will evaluate its own effect and effect of its group colleagues on the ability of the product to accept changes and risk of failure. The invention helps find group of metrics, which affect changeability, and failure proneness of object-oriented source code modules. Association rules are extracted and on the basis of which the source code developers can improve their development plans before starting work on the next version of their object oriented software.

Software metrics: Software metric is the measurement of some specific property of software. Metrics are used to measure software at fine-grained and at coarse-grained level. In the instant invention, software metrics are utilized to define a criterion for evaluation of object-oriented software. The metrics are applied only on the source code of software.

Success Indicator: The success criterion differs across the systems. There are number of variables which can contribute to define the extent of success of a particular system. These variables can be pruned to identify crucial features for success. They are termed as Success indicators. Changeability and failure proneness are success indicators in object-oriented source code modules.

Changeability: In the instant invention, the term is used to define the ability of software source code to accept changes.

Failure proneness: The likelihood of software component to fail.

Object-Oriented metrics: The metrics are used to evaluate the object-oriented characteristics. These metrics were proposed by NASA Goddard space flight center. Within this framework, nine metrics for object-oriented development were selected. These include three traditional metrics and six specific metrics to evaluate principal object-oriented structures.

Complexity metrics: These metrics are used to evaluate the complexity of source code of an object-oriented source code module.

Association rules: Association rule mining is used to unhide interesting associations (relationships) among variables. This is done on the basis of frequency of occurrence of an item in a transaction database. In this invention, association rule mining is used to discover relationship among different software metrics and relationship of these metrics with success indicators.

### BACKGROUND

Changeability and failure proneness are considered as success indicators for the project. Changeability means how flexible the source code will be, for change. The changeability of object-oriented designs is assessed by Nikolaos Tsantalis et al., [6]. Nikolaos estimated change proneness of object-oriented design by evaluating the probability that each class of systems will be affected when new functionality is added or when existing functionality is modified. If a change in one module would necessitate a change in another module, the effect is called ripple effect [21]. So a module including class, functions and packages with higher ripple effect is considered less changeable, in this research.

Failure prone software entities, of course was the second major factor affecting the success of OO software code modules. Nachippan Naggappan et. al., [5] found that failure prone software entities are statistically correlated with code complexity measures. Nachi mined complexity metrics and found correlation of these metrics with post-release defects to predict failure of a specific software component.

Claes Wohlin et. al [14] considered “In time delivery” as success indicator for software projects. Gerd Kohler et al., [11] focused on internal quality of object-oriented software as success indicator. Magiel Bruntiunk et al., [10] have preferred class testability as success indicator. Our approach is exclusively concerned with finding the dependency of changeability and failure proneness on different aspects of source code components and to group the metrics that vary together to affect the mentioned changeability and failure proneness.

Junya Debari et al., [1] applied association rule mining to extract improvement action items in order to complete a software project within the allocated budgets. The association rules are grouped and ranked with respect to the value of the metric “cost overrun”.

Qinbao et al., [2] predicted software defect association and defect correction effort by extracting association rules from SEL software repository. The prediction in comparison with prediction power of PART, C4.5 and Naïve Bayes [8] showed 23% improved accuracy.

In this invention, the term “Critical Factor” referred to the aspect, which needs more resources and effort of personnel. How much effort should be consumed on a particular aspect of source code? A critical value was assigned to each aspect with respect to its correlation value with success indicators. The effort that should be consumed on a particular aspect can be calculated then. The exact division of manpower and resources according to the critical value can be considered as future extension to this work.

A software metrics tool, called Crocodile, was developed at the Technical University in Cottbus [15]. It is used to focus the attention of an inspector to critical parts of the software. This focusing is based on quantitative measurements of structural properties of the object-oriented system. Crocodile does not deal with source code details. It only considers packages (e.g. Java packages or subsystems), classes with inheritances and associations, their methods/attributes and their usage.

Nachippan et al., [5] mined object-oriented metrics to predict failure prone components prior to the release of software. They made an empirical study of post release defects history of five Microsoft systems and found that the failure prone software entities are statistically correlated with code complexity measures. They were unable to find out a single set of metrics, which can act universally as best defect predictor. Nachi collected input data for mining from Bug Database, Version Database and Code modules. They mapped postrelease defects in entities with source code components. All the entities went through prediction mechanism to generate failure probability of the particular entity. Nachi et al., obtained a set of complexity metrics that correlates with post-release defects. They remained unable to find a single set of metrics that fit all projects.

Adrian Schrooter et al., [3] made an empirical study of 52 ECLIPSE plug-ins to find that software design as well as past failure history can be used to build support vector machines, which predict failure-prone components in new programs. They concluded that component likelihood to fail is significantly determined by the set of components it uses.

Another related work was carried out by Ajmal Chaumun et al., [7] in which Chaumun assessed the changeability of an object-oriented system by computing the impact of changes made to the classes. Chaumun concluded that object-oriented design metrics can be used as indicators of changeability.

The set of metrics included in this research include (1) Object-oriented metrics. (2) Complexity metrics. The mentioned OO metrics were proposed by NASA Goddard space flight center. The project discussed an approach to choose metrics for an object-oriented project by first identifying the attributes associated with object-oriented development [4] [13]. Within this framework, nine metrics for object-oriented development were selected. These include three traditional metrics adapted for an object-oriented environment and six new metrics to evaluate principal object-oriented structures [Table 1].

TABLE 1
SATC metrics for object-oriented Constructs

| | | Object-Oriented |
|---|---|---|
| Source | Metric | Construct |
| Traditional | Cyclomatic complexity (CC) | Method |
| Traditional | Lines of Code (LOC) | Method |
| Traditional | Comment percentage (CP) | Method |
| NEW Object-Oriented | Weighted Methods per class | Class/Method |
| | (WMC) | |
| NEW Object-Oriented | Response for a class (RFC) | Class/Method |
| NEW Object-Oriented | Lack of cohesion of methods | Class/Cohesion |
| | (LCOM) | |
| NEW Object-Oriented | Coupling between objects | Coupling |
| | (CBO) | |
| NEW Object-Oriented | Depth of inheritance tree | Inheritance |
| | (DIT) | |
| NEW Object-Oriented | Number of children (NOC) | Inheritance |

A number of software metrics have been proposed to assess software effort and quality [12] [17]. Chidamber and Kemerer [18] validated a set of metrics used to evaluate complexity. Ohlsson and Alberg [16] investigated a number of traditional design metrics to predict modules that were failure prone. On the basis of mentioned studies, the selected complexity metrics were classes volume, function volume, global variable volume, lines volume, parameter volume, read coupling, write coupling, procedure coupling, fan in, fan out and adder taken coupling.

### BRIEF DESCRIPTION OF DRAWINGS

FIG. 1: Flowchart of the proposed approach used to create association rule mining

FIG. 2: Bar chart showing the impact of different combinations of set of metrices on changeability and failure proneness

### DETAILED DESCRIPTION

The subjective as well as objective evaluations of software have been made by researchers but the phenomenon that is immature in this domain is “Prediction”. Most of the healthy efforts been made are for generic software. A specific class of systems i.e., object-oriented systems are assessed by Reiner R. Dumke and Erik Foltin [9], by Ajmal Chaumun and Rudolf K. Keller [7] and by some other researchers. The previous efforts for making predictions need a few enhancements.
The group of factors in source code development should be identified that vary together to affect changeability and failure proneness of software.
It was assumed that the Object Oriented source code is assessed by Object Oriented metrics. There are other metrics (e.g. Complexity metrics in this invention), which can contribute in Object Oriented software measurements.
How the development plan can be changed after identification of above factors.

The proposed approach is explained in the steps below.

Step 1: In the design phase we calculate the values of specific metrics set on previous history data collected from software version and usage profiles.

Step 2: We analyzed correlation of the metric in metrics set with the two success indicators i.e., number of changes in modules, number of defects in modules hence resulting in correlation table of metrics set with changeability and failure proneness.

Step 3: Based on the values of correlation table, we derived association rules by applying a priori algorithm [19].

Step 4: Finally, the factors that vary together to affect changeability and failure proneness (hence the success of object oriented module) are derived.

Association rule mining sometimes lead to meaningless rules. To avoid these rules, support and confidence are the two parameters, which can remove uninteresting rules [1].

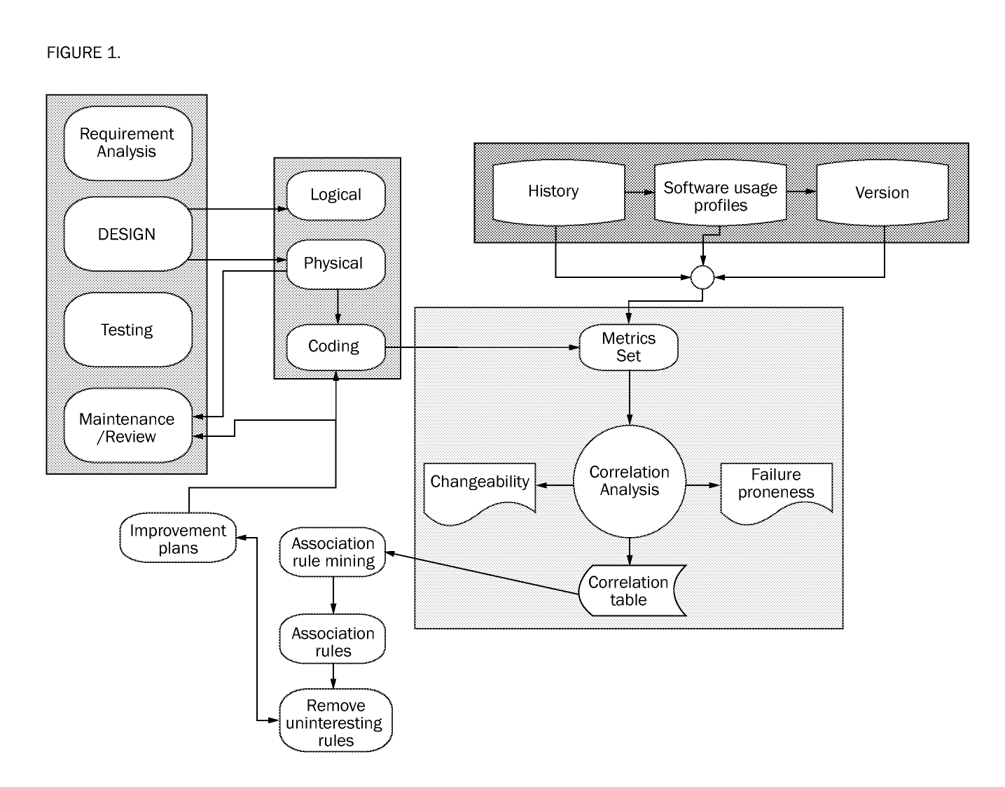

The proposed approach is described in FIG. 1.

FIG. 1

FIG. 1. Proposed approach to association rule mining.

The source code of benchmark projects was written in object-oriented programming languages. The data about all these projects were collected from history database, version database and software usage profiles. The projects collected from software industries were more convenient with respect to collection of data because these industries maintained the three required repositories. The projects collected from students' community were not much consistent in this regard. However, these projects have been executed in the respective organizations for specific period of time to build required repositories.

After extraction of data, the first and the most prior test was “Correlation analysis” of all the inputs with Changeability and failure proneness. The medium used to get the results of correlation analysis of metrics applied to these code modules, was Software Project Predictor “SPP” (Customized software for this research).

All the mentioned projects were release-based and the releases were working up to the desired standards of clients. The experiment took place at Department of Computer Sciences & Engineering, University of Engineering & Technology Lahore during the session 2008 as part of a full-year (two semesters) project.

### Proposed Approach to Association Rule Mining

Association rule mining aims to build user comprehensible rules by extracting frequent patterns and associations among item sets [22]. An association rule X [symbol] Y means that if an event X happens, an event Y happens at the same time. Event X is called antecedent, and Y is called conclusion [1]. In this project association rule will be in the form

[symbol]

(μ,S0) [symbol] (changeability=“Flexible”) (Eq.1)

[symbol]

(μ,S1) [symbol] (component failure=“not expected”) (Eq.2)

[symbol]

[(μ1, μ2, μ3, . . . , μn),S0] [symbol] (changeability=“Flexible”) (Eq.3)

[symbol]

[(μ1, μ2, μ3, . . . , μn),S1] [symbol] (component failure=“Not expected”) (Eq.4)

[symbol]

represents strong correlation, μ is the metrics name where as S0 and S1 represents success indicators.

Using A priori algorithm [19] association rules are generated in two steps.

### 1—Determine Frequent Item Sets

e.g. with the A priori algorithm

### 2—Determine Association Rules

e.g., for each frequent item set I for each subset J of I determine all association rules of the form: I−J=>J

“Support” and “confidence” are the parameters for evaluation of importance of an association rule. Support indicates the percentage of the data, which contains both the antecedent and consequent of the Association Rule [1].

Support(X [symbol] Y)=P(X∪Y)

Confidence is the ratio of number of transactions that contain (X∪Y) to the number of transactions that contain X for the Association Rule X [symbol] Y.

$$Confidence ( X ⋃ Y ) = \frac{Support ( X ⋃ Y )}{Support ( X )} = P ( Y / X )$$

On the basis of these two measures, small numbers of interesting association rules are selected omitting the rest. The dataset with strong correlation values are stored in another database and the association rules are mined from new dataset. As an example it has been observed that

Correlation [(LCOM, CBO, Class coupling, ParamVol), Changeability]=“Bold”

Hence the rule will be

[(LCOM, CBO, Class coupling, ParamVol), changeability] [symbol] (changeability=“Flexible”)

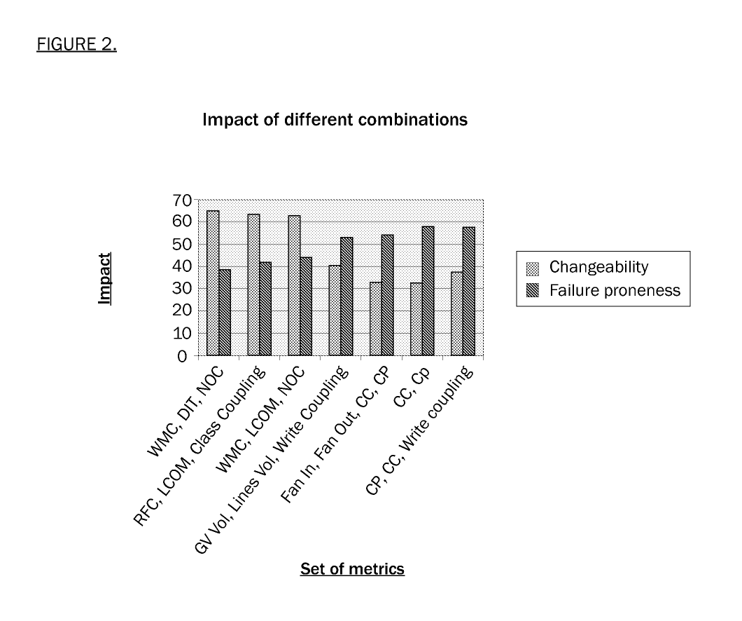

By the above stated methodology it is also possible to visualize the impact of different combinations of software metrics on success indicators. As an example the above graph has been taken to visualize a few impacts. (FIG. 2)

FIG. 2.

FIG. 2. Impact of different combinations on set of metrices.

The work done in this project was majorly focusing upon the object oriented software development. The reason to choose object oriented systems, as the area of work was two fold. Most of the development in IT industry is based on Object Oriented methodologies and structures. Some prediction efforts had already been made though those efforts were not largely based on software metrics. The domain of prediction about Object Oriented Systems was still immature.

In summary, modern object oriented developments produce an abundance of recorded process and product data that is now available for automatic treatment. Systematic empirical investigation of this data will provide guidance in several software engineering decisions and further strengthen the existing empirical body of knowledge.

### REFERENCES

1. Junya Debari, Osamu Mizuno, Tohru Kikuno, Nahumi Kikuchi, Masayuki Hirayama. ‘On deriving actions for improving cost overrun by applying association rule mining to industrial project repository.’ Making globally distributed software development a success story, Springer Berlin/Heidelberg, Pages 51-62, May 2008.
2. Qinbao Song, Martin Shepperd, Michelle Cartwright, Carolyn Mair. ‘Software Defect Association mining and defect correction effort prediction.’ IEEE Transactions on Software Engineering, Vol. 32, No. 2. February 2006.
3. Adrian Schroter, Thomas Zimmermann, Andreas Zeller. ‘How design predicts failures.’ Proceedings of the 5th International Symposium on Empirical Software Engineering, Pages 18-27, September 2006
4. Julien Rentrop, ‘Software Metrics as Benchmarks for Source Code Quality of Software Systems’, Software Improvement Group NASA. 2006
5. Nachiappan Nagappan, Thomas Ball, Andreas Zeller. ‘Mining Metrics to predict component failure’. Microsoft Research Redmond, Wash. 2005
6. Nikolaos Tsantalis, Alexander Chatzigeorgiou (Member IEEE), George Stephanides. ‘Predicting the Probability of Change in Object-Oriented Systems.’ IEEE Transactions on Software Engineering. Vol 31 No.
7. July 2005. 7. M. Ajmal Chaumun, Hind Kabaili, Rudolf K. Keller, Francois Lustman. ‘A Change Impact Model for Changeability Assessment in Object-Oriented Software Systems.’ Proceeding of 16th IEEE International Conference on tools with Artificial Intelligence. 2004
8. Arun K Pujari. ‘Data Mining Techniques.’ Universities Press (India) Private Limited. 2004
9. Reiner R. Dumke, Erik Foltin. University of Magdeburg Germany. IEEE Software, 2004.
10. Magiel Bruntink, Arie Van Deursen. ‘Predicting Class Testability using Object-Oriented Metrics.’, Proceedings of the fourth IEEE International Workshop on Source Code Analysis and Manipulation. 2004
11. Gerd Kohler, HeinRich Rust, Frank Simon. ‘An Assessment of Large Object Oriented Software Systems’, Technical University of Cottbus Germany, ACM Press. 2002
12. Norman E. Fenton, Martin Niel. ‘Software Metrics: Roadmap.’ Department of Computer Sciences, Queen Mary and Westfield College London. ACM Press 2000
13. Linda H. Rosenberg, Larry Hyatt. Applying and Interpreting Object Oriented Metrics. NASA Research. Journal of Object-Oriented programming (November 2000)
14. Claes Wohlin, Anneliese von Mayrhauser. ‘Assessing Project Success using Subjective Evaluation factors’, Department of Communication Systems Lund University. 2000
15. Claus Lewerentz, Frank Simon: A product metrics tool integrated into a software development environment, Published in Proceedings of the European Software Measurement Conference FESMA, Belgium 1998.
16. N. Ohlsson, Alberg, H., “Predicting fault-prone software modules in telephone switches”, IEEE Transactions in Software Engineering, 22(12), pp. 886-894, 1996.s
17. Norman Fenton: Software Metrics, a rigorous approach, International Thomson Computer Press London, 1995.
18. S. R. Chidamber and C. F. Kemerer, ‘A Metrics Suite for Object Oriented Design’, IEEE Transactions on Software Engineering, 20(6), pp. 476-493, 1994.
19. Agrawal, R. and Srikant, R. Fast Algorithms for Mining Association Rules in Large Databases. International Conference on Very Large Databases. pp 487-499. 1994
20. Agrawal, R., Imielinski, T., and Swami, A. N. 1993. Mining association rules between sets of items in large databases. Proceedings of the 1993 ACM SIGMOD International Conference on Management of Data, pp. 207-216.
21. F. M. Haney, “Module Connection Analysis—A Tool for Scheduling of Software Debugging Activities,” Proc. AFIPS Fall Joint Computer Conf., pp. 173-179, 1972. 12-13

I claim:

1. A computer based method for extraction of association rules from software data repository including software version database and usage profiles comprising
a. Generating set of association rules with higher confidence
b. Specifying the prominence of said rules with respect to their effect on source code development for new software release
c. Predicting classification of various combinations of software metrics on source code development for coming release of software
d. Specifying the effect of various combinations of software metrics on success indicators of software source code.

2. The method of claim 1 wherein said association rules are evaluated by method of software metrics.

3. The method of claim 1 wherein said source code is object-oriented.

4. The method of claim 1 wherein correlation analysis is applied to relate source code development factors with changeability and failure proneness of components of the system.

5. The method of claim 1 wherein said data repository is converted to another equally sized repository that contains values obtained by applying software metrics on the raw data and factors determined that vary together to affect acceptance of change (changeability) and failure proneness of software source code.

6. The method of claim 5 where software metrics are divided into complexity metrics and object-oriented metrics.
